(19) United States
(12) Patent Application Publication
(10) Pub. No.: US 2003/0117972 A1
(43) Pub. Date: Jun. 26, 2003

(54) Hardware arrangement, cellular network, method and cellular terminal for processing variable-length packets

(76) Inventor: Markku Vimpari, Oulu (FI)

Correspondence Address: PERMAN & GREEN, 425 POST ROAD, FAIRFIELD, CT, 06824, US

(21) Appl. No.: 10/147,182

(22) Filed: May 15, 2002

(30) Foreign Application Priority Data
Dec. 21, 2001 (FI) 20012555

(51) Int. Cl. H04Q 7/00; H04J 3/24

(52) U.S. Cl. 370/328; 370/473

(57) ABSTRACT

The invention relates to a hardware arrangement and method for keeping the error rate FER of the basic packets included in RTP packets communicated in a packet-switched telecommunication network (11) at a desired level. In the method according to the invention, the number of basic packets to be included in RTP packets is changed according to the frame error rate FER of the last received RTP packets if it either exceeds or drops below a predetermined threshold value.

The invention relates to a converter to be used in conjunction with a telecommunication network, which converter is arranged so as to receive and transmit basic packets, which contain one data block, as RTP packets according to the IETF standard RFC 1889. The invention also relates to a software means for implementing the converter. The invention further relates to a telecommunication network in which the converter is used. The invention additionally relates to a telecommunication network terminal, which is able to utilize variable-length RTP packets.

As networks are being digitalized, data communications is more and more beginning to rely on packet-switched connections. With the spread of the Internet, packet-switched data communications has become a de facto standard for non-real-time applications. Data communicated on a packet-switched connection used in the Internet are organized in multiple data blocks, or packets, which include 65,535 bytes at the most as well as an address specifying the recipient. At the recipient, the received data packets are reorganized in the correct order for processing. Especially in non-real-time applications, including various data communications connections between computers, this technology involves considerable benefits in the utilization of communications networks as network capacity is used only when there is data to be transferred. Each packet has a header to guide it to the correct destination. In a fixed communications network there is on average enough communications capacity, so the size of the header is no problem. Thus the IPv4 Internet Protocol, which is currently widely used in the Internet, uses a 20-byte header, and the forthcoming IPv6 uses a 40-byte header.

Real-time audio and video connections, which, until now, have mostly relied on circuit-switched technology, are also beginning to transform into packet-switched Internet-type connections. Methods for the so-called VoIP (Voice over IP) are being currently developed and standardized. The nature of VoIP, however, imposes new requirements on the transfer of packets from a sender to a recipient, because the packets have to be at the disposal of the recipient at certain precise moments of time in the correct order and delayed by a certain maximum delay at the most, usually less than 150 ms. In this case the IP protocols used in the conventional packet-switched communications are heavy to use. Large headers in each packet transferred slow down packet processing and eat up transfer capacity.

Real-time packet-switched connections thus require more efficient transfer methods, which can make data communications more effective in real-time applications. A compression method called Robust Header Compression (ROHC) is being developed under the Internet Engineering Task Force (IETF). In the ROHC method, only the header information that was changed from the previous packet is added to the packet transferred. However, the defining of the ROHC is still under way and apparently will take several years to complete and, moreover, its application to wireless connections is problematic, since it has a limited error recovery capability.

It is also known a method for enhancing data communications, in which method the header is at least partly removed. This method is proposed to be used for radio-based connections in a third-generation cellular network defined in the 3^{rd} Generation Partnership Program (3GPP). Use of the method, however, requires that a separate radio path is allocated for a connection employing this method and, therefore, it resembles a conventional circuit-switched connection as regards its characteristics. Real-time packet-switched data transfer is based on the IETF standard RFC 1889, which defines the Real Time Protocol (RTP) to be used in real-time data communications. Packets belonging to an audio or video stream must be organized in the correct order at the receiving end, and that is just what the RTP is used for. If a packet was lost on the way, the received packets can, however, be played out at the right moment. For example, a lost speech packet is masked by a speech codec, i.e. in practice the last sound is extended at a damped level. The header of a standard RTP packet is shown in Table 1.

TABLE 1
RTP protocol header

0 1 2 3
0 1 2 3 4 5 6 7 8 9 0 1 2 3 4 5 6 7 8 9 0 1 2 3 4 5 6 7 8 9 0 1
+−+−+−+−+−+−+−+−+−+−+−+−+−+−+−+−+−+−+−+−+−+−+−+−+−+−+−+−+−+−+−+−+
|V=2|P|X| CC |M| PT | Sequence Number |
+−+−+−+−+−+−+−+−+−+−+−+−+−+−+−+−+−+−+−+−+−+−+−+−+−+−+−+−+−+−+−+−+
| Timestamp |
+−+−+−+−+−+−+−+−+−+−+−+−+−+−+−+−+−+−+−+−+−+−+−+−+−+−+−+−+−+−+−+−+
| Synchronization Source (SSRC) Identifier |
+−+−+−+−+−+−+−+−+−+−+−+−+−+−+−+−+−+−+−+−+−+−+−+−+−+−+−+−+−+−+−+−+
| Optional contributing source (CSRC) identifiers |
| .... |

As can be seen from Table 1, a standard RTP protocol header is at least 12 bytes long per data packet transferred. The RTP is advantageous especially when transferring video in a fixed network. Transmission according to the RTP to a receiver need not always occur at regular intervals, which can be utilized in video transfer where the amount of data transferred may vary a lot from one moment to another.

Packet-switched communications based on the IP is making its way into wireless communication systems as well. In these systems the radio path limits the transmission band available to each transmission link so that it is clearly narrower than that available to conventional wired connections. The 12-byte header required by the RTP almost corresponds to the size of a 20-ms sound sample block generated by one adaptive multirate (AMR) speech codec, which at the lowest bit rate of AMR is 13 bytes. As the RTP thus reserves a considerable portion of the transmission capacity available for a wireless connection, it cannot be efficiently used as such in the transfer of audio signals in this case.

The capacity-consuming effect of the header can be reduced by including in one packet more data blocks containing advantageously consecutive sound samples. One packet could contain e.g. three such data blocks. The frame error rate (FER) could prove problematic with this method. System usability usually requires that the FER is less than 2%. If, however, several separate sound samples are attached to one and the same packet, a 2% FER value will mean that the FER of an individual speech block will increase by 6%, which is unacceptable in real-life applications. This situation will easily occur in the fringe areas of the serving cell where noise-induced interference is stronger than in the core area of the cell. As a high number of packets must be rejected because of the high FER value, less data will be received per unit time.

A packet-switched network may also utilize channel coding by means of which it is possible to trade between the amount of data transferred and the error resilience of the data. In a GPRS network, for instance, there are four different channel coding classes CS-1 to CS-4. In CS-1, the data rate after channel coding is 9.05 kbps and in CS-4 it is 21.4 kbps. In CS-4, channel coding is not used at all. CS-4 is suitable for situations in which the operating environment is almost interference-free, i.e. in the core area of a cell, and CS-1, in which the channel coding is the strongest, is suitable for situations in which the operation occurs in the fringe areas of the serving cell. So, in the fringe areas of a cell, the user's data rate is clearly lower than at the core of the cell. Effective utilization of channel coding will result in that the quality of service is different in the different areas of a cell. Especially in a fringe area of a cell, the data rate for the customer may drop rather low because of strong coding.

An object of this invention is to provide a new method and hardware arrangement where the communications capacity in a packet-switched network can be utilized in different areas of a serving cell in a more versatile manner than in the prior art.

The objects of the invention are achieved using a hardware arrangement to change the number of data blocks included in RTP packets transferred in a packet-switched network on the basis of a quality parameter measured for a communications connection, which quality parameter describes said connection.

A converter according to the invention is characterized in that it is arranged to determine the number of basic packets to be included in an RTP packet to be transferred on the basis of a quality parameter determined from previous received RTP packets.

A telecommunication network according to the invention is characterized in that it comprises both a converter connected to a backbone network and means in terminals for determining the number of basic packets to be included in an RTP packet according to the IETF standard RFC 1889 on the basis of a measured quality parameter describing the quality of a communications connection.

A telecommunication network terminal according to the invention is characterized in that it comprises means for determining the number of basic packets to be included in RTFP packets on the basis of a quality parameter describing the quality of a communications connection.

A method according to the invention to be used in a telecommunication network is characterized in that the number of basic packets to be included in RTP packets in communication between a converter and terminal is determined on the basis of a quality parameter describing the quality of a communications connection.

Advantageous embodiments of the invention are presented in the dependent claims.

The idea of the invention is basically as follows: A hardware arrangement according to the invention makes use of adaptively varying packet lengths on the RTP level. The better the conditions on a communications connection, the greater the number of data blocks that can be attached to a single RTP packet to be transferred. If, on the other hand, the conditions on the communications connection become worse, the number of data blocks, hereinafter called basic packets, to be included in a single RTP packet is reduced. This way it will be possible to keep the error rate FER of an individual basic packet on an acceptable level, which is less than 10%. Conversely, in good conditions it is possible to benefit from the decrease of the average proportion of header data per one basic packet in the longer RTP packets and to transfer more user data per unit time on the same physical transfer channel.

An advantage of the invention is that an acceptable FER value per basic packet can be provided also in the fringe areas of a cell, better than with prior-art methods.

Another advantage of the invention is that the maximum capacity of a physical channel can be provided for a user in the core area of a cell by minimizing the RTP packet header overhead per basic packet by combining in a single RTP packet several basic packets having the same destination.

A further advantage of the invention is that no changes are necessary in the backbone network functions.

The invention is below described in detail. Reference is made to the accompanying drawings in which

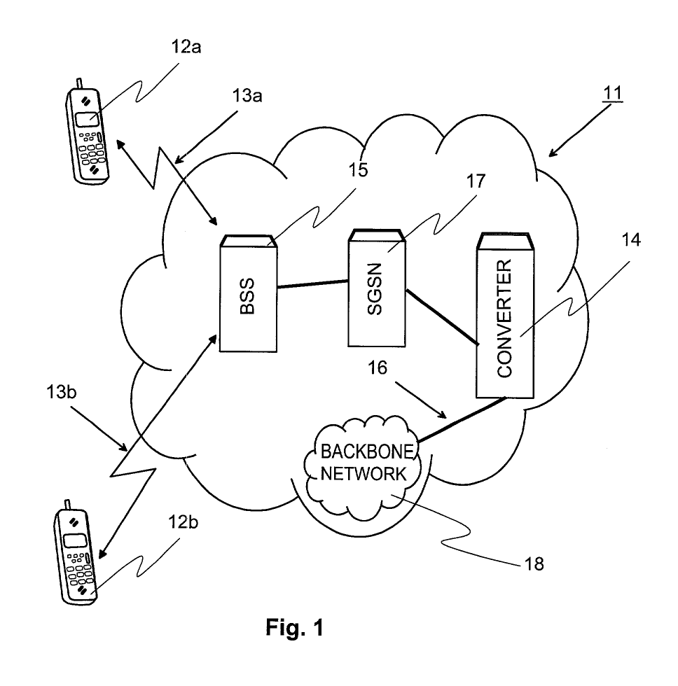

FIG. 1 shows by way of example a hardware arrangement according to the invention in a cellular network,

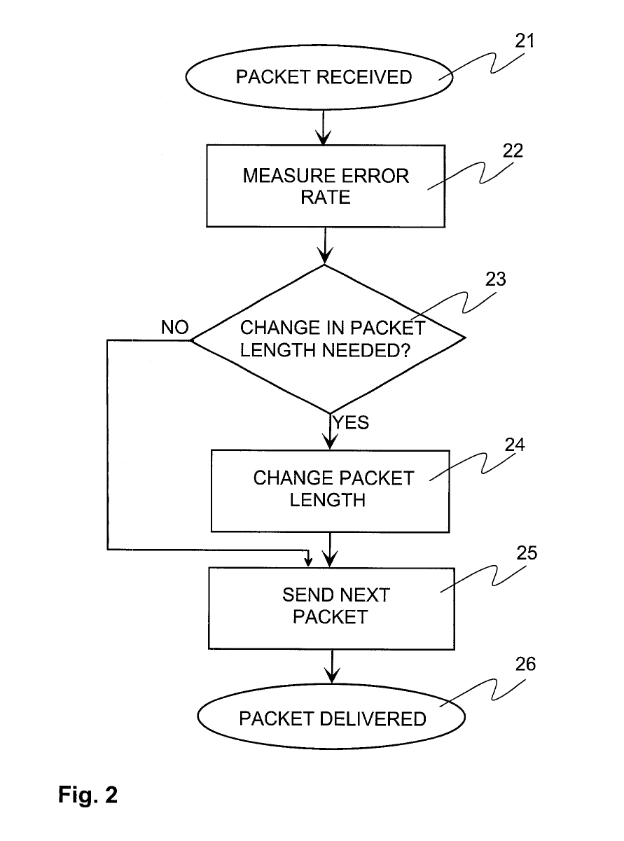

FIG. 2 shows by way of example a flow diagram of the main stages of a method according to the invention, and

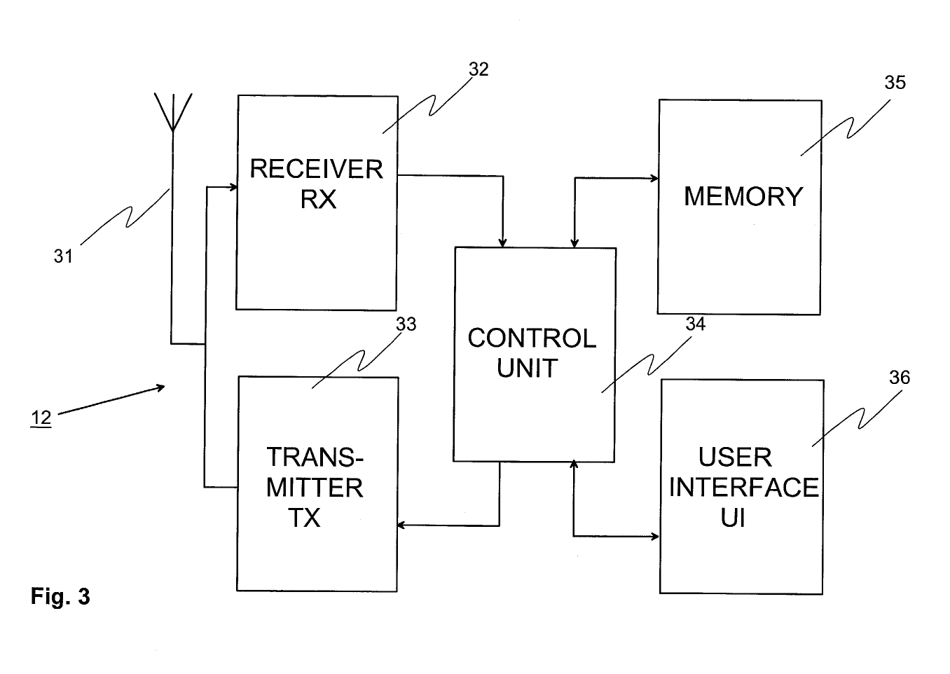

FIG. 3 shows by way of example a terminal according to the invention used in a cellular network.

FIG. 1 shows, by way of example, a hardware arrangement according to the invention. This hardware arrangement makes it possible to advantageously utilize for a speech connection an RTP packet the length of which varies according to the circumstances. The variable-length RTP packet is advantageously used for wireless connections 13a, 13b of a telecommunication network, especially in fringe areas of the network where the communications system is mainly noise-limited. However, in the core area of the wireless network or in the backbone network 18, which is usually capacity-limited, it is advantageous to use long RTP packets, which advantageously contain a fixed number of separate basic packets. A standard RTP protocol means here and hereinafter a protocol according to the IETF standard RFC 1889.

Reference designator 11 in FIG. 1 refers to a digital cellular network in which at least part of the communication is packet-switched. Such a network may be e.g. a GPRS (General Packet Radio Services) network. The backbone network is denoted by reference designator 18 and it advantageously employs a standard RTP protocol in conjunction with real-time applications. Naturally, the backbone network 18 can be thought to exist outside the exemplary ‘cloud’ that represents the GPRS network. One element in the backbone network is a so-called operating node, or Serving GPRS Support Node (SGSN) 17 via which packets from the backbone network 18 are directed to a, certain base station subsystem (BSS) 15. Advantageously between the SGSN 17 and backbone network 18 there is coupled a converter 14 according to the invention to carry out the length changes of the RTP packets. From the backbone network 18 the packets are transferred up to the converter 14 advantageously in fixed length using a standard RTP protocol, reference designator 16. Thus the length of the packets transferred is fixed, and they advantageously contain several sound samples/basic packets per RTP packet transferred.

The converter 14 according to the invention can change the length of a fixed RTP packet by increasing or decreasing the number of basic packets belonging to an RTP packet for a wireless communications connection 13a, 13b. For a terminal 12a, 12b to be able to utilize variable-length RTP packets according to the invention in the transmission and reception of basic packets, it contains software means, which enable it to know or deduce how many basic packets are included in one RTP packet.

Operation according to the invention requires that both the terminals 12a, 12b and the converter 14 according to the invention comprise means for calculating the frame error rate FER or measuring some other parameter describing the quality of the communications connection for each RTP packet received, as well as means for changing the transmission length/reception length of RTP packets in accordance with the last error ratio measured.

The number of basic blocks included in the basic packets can be determined from the received data. For example according to IETF standard RFC 3267 every RTP packet contains in the payload a header, which is used in connection with an AMR block. The header comprises Table of Context (TOC), which contains information about the number of basic blocks included in the packet. The receiver can use this information and calculate the number of AMR blocks included in the received RTP packet.

If the receiving party is a converter 14 according to the invention, it advantageously combines short basic packets received from a wireless connection 13a, 13b and forwards them to the backbone network 18 in the form of longer RTP packets including several basic packets, whereby they can be transferred more efficiently than by sending them individually in their reception format. If a packet to be combined is lost, it is replaced by an empty basic packet the length of which may be one byte, containing information that this spot has to be masked during playout. Thus in the backbone network it will be possible to use prior-art methods and protocols despite the fact that on the wireless connection 13a, 13b methods are used that differ from the prior art.

FIG. 1 shows, by way of example, two terminals 12a and 12b. The wireless connection 13a to terminal 12a is so good that RTP packets including e.g. three separate AMR basic packets can be used over the link 13a. A basic packet contains a plurality of compressed sound samples; advantageously 8000 samples taken/s in a 20 ms time period, or 160 samples. The wireless connection 13b is, however, noise-limited, which increases the frame error rate. The longer the RTP packet, the greater the average FER per basic packet. Therefore, the party that last received RTP packets will at some point indicate to the sending party that the FER exceeds a predetermined limit. Subsequently the parties will use in the next transmission RTP packets in which the number of basic packets has been decreased, whereby the average FER per basic packet decreases accordingly.

Use of the invention will not prevent simultaneous use of other methods aimed to enhance the robustness of a connection. So, for a given connection it is possible to use, in addition to the method according to the invention, channel coding according to the GPRS standard, for example. Channel coding is changed according to changes in the bit error rate (BER) or, in the case of packet data, according to changes in the block error ratio (BLER), and thus by using more effective channel coding it is possible to correct more errors within a packet received. Strong channel coding, however, reduces the proportion of data transferred on a physical transfer channel. If the cellular network is not capacity-limited at its fringe areas, more time-slots can be allocated to the same connection 13a, 13b, if necessary, so that the data transfer rate will stay tolerable, from the user's point of view, even when using strong channel coding.

FIG. 2 shows, by way of example, a flow diagram of the main stages of the operation of a hardware arrangement according to the invention, which may take place either at the converter 14 or at a terminal 12a, 12b.

By using a converter 14 according to the invention, as illustrated in FIG. 1, it is possible to utilize variable-length RTP packets on a wireless connection 13a, 13b. The converter 14 according to the invention is either a discrete device in the network 11 or part of a functional unit in the cellular network 11, such as an operating node 17. The converter 14 according to the invention is advantageously used for speech connections with a mobile terminal 12a, 12b when the communications connection 13a, 13b is packet-switched and the packets transferred are voice packets. Thus it is possible to receive packets of any length from the wireless connection 13a, 13b, depending on the application. From the backbone network 18, however, the converter 14 according to the invention advantageously receives only RTP packets of a fixed length.

In step 21 in the exemplary flow diagram of FIG. 2, the converter 14 according to the invention or a terminal 12a, 12b receives a packet from the radio path 13a, 13b. In step 22 a parameter is measured which describes the quality of transmission of the RTP packet received. The measurement may concern the frame error rate FER or a computational result simulating that ratio on the basis of a measurement of the block error ratio BLER or bit error rate BER, for example. The signal-to-interference ratio (SIR) may also be used.

In step 23, the quality parameter, say the frame error rate FER, measured for the RTP packet received, is matched against predetermined threshold values. The results of a few earlier such measurements are also taken into account. The threshold values can be changed by means of a message sent from the receiving end. There may advantageously be one threshold value per each RTP packet length so that the RTP packet length can be changed up or down by one basic packet e.g. according to the FER measured. If the magnitude of the FER measured is such that it does not call for a change in the number of basic packets to be included in the RTP packet transmitted, the process moves on direct to step 25. If the result of the error ratio measurement shows that the number of basic packets to be included in the RTP packet needs/allows a change, the process moves on to step 24.

Another alternative to determine whether a change is needed in the length conversion is to signal, back to the transmitting end, the information about the error ratio measured for the previous packets sent in the direction in question. This can be done by using RTCP (Real-Time Control Protocol), which is included in the RTP.

In step 24, the number of basic packets to be included in the RTP packet can be either increased or decreased. If the frame error rate FER indicates an increase in the number of errors, the number of basic packets is advantageously decreased by one in the next RTP packet sent. If, on the other hand, the FER measurement shows that the number of errors has decreased because of a better transmission channel, the number of basic packets to be included in the RTP packet is increased advantageously by one in the next RTP packet sent.

In step 25 it is sent the next RTP packet, which contains a different number of basic packets than the previous RTP packet sent. In step 26 the RTP packet has been delivered across the wireless connection 13a, 13b. After that, the device that sent the packet is ready to either receive an RTP packet or send the next RTP packet using the RTP packet length adopted in step 24.

FIG. 3 shows, by way of example, main components of a wireless terminal 12 belonging to a hardware arrangement according to the invention. The terminal 12 uses an antenna 31 to send and receive packets. Reference designator 32 represents the means that constitute a receiver RX and with which the wireless terminal 12 receives also RTP packets from a cellular network 11. The receiver RX comprises prior-art means for all packets received. Therefore it advantageously also comprises means for measuring transmission errors both in the form of bit error rate BER and frame error rate FER or block error ratio BLER. It is also possible to use some other quality meter, such as the SIR, the values of which correlate to the frame error rate FER in a known manner when the modulation and channel coding are known.

Reference designator 33 represents the means that constitute the transmitter TX in the wireless terminal. The transmitter means 33 carry out on the signal transmitted all the signal processing measures that are necessary when operating with a cellular network 11.

An essential functional unit as regards application of the invention is the control unit 34 that controls the operation of the terminal 12. It controls the operation of all main components of the terminal 12. The control unit controls both the receiver and transmitter functions. It is also used in the management of the user interface UI 36 and memory 35. In the hardware arrangement according to the invention the control unit 34 determines the length of the RTP packets on the basis of the frame error rate FER that was measured last or that was signaled from the receiving end, in practice from the network converter. The control unit 34 also disassembles the received RTP packets into separate basic packets for further processing if long RTP packets were used on the connection 13a, 13b. Furthermore, in transmission, it may combine several basic packets into one RTP packet to be transmitted if allowed by the frame error rate measurement. The error ratio table needed by the control unit 34 to determine the packet length is advantageously located in the memory 35. The memory advantageously also includes the software means used to change the length of the RTP packet transmitted.

The user interface UI 36 is used for controlling the functions of the terminal. Via the user interface the user is able to specify the device with which he wants to communicate.

A few embodiments of the invention were described above by way of example. The invention is not limited to the explanatory solutions described above. For example, the converter according to the invention, which changes the length of the RTP packet, may also be part of some other structure of the backbone network than the operating node shown in FIG. 1. For instance, it may be part of a server operating in a backbone network. Likewise, the communications protocol may be any appropriate protocol. The inventional idea can be applied in numerous ways within the scope defined by the claims attached hereto.

1. A converter used in conjunction with a telecommunication network, arranged so as to receive and transmit basic packets, which contain one or more data blocks, in the form of RTP packets according to the IETF standard RFC 1889, wherein the converter is arranged so as to determine on the basis of a quality parameter determined from previous received RTP packets the number of basic packets to be included in an RTP packet to be transmitted.

2. A converter according to claim 1 wherein said quality parameter is one of the following: frame error rate FER, block error ratio BLER, bit error rate BER, signal-to-interference ratio SIR.

3. A converter according to claim 1 wherein the converter is arranged so as to reduce the number of basic packets in an RTP packet by one when the value of a quality parameter describing the quality of a connection exceeds a predetermined threshold value if the quality parameter is one of the following: FER, BER, or Bler.

4. A converter according to claim 1 wherein the converter is arranged so as to reduce the number of basic packets in an RTP packet by one when the value of a quality parameter describing the quality of a connection drops below a predetermined threshold value if the quality parameter is SIR.

5. A converter according to claim 1 wherein the converter is arranged so as to increase the number of basic packets in an RTP packet by one when the value of a quality parameter describing the quality of a connection drops below a predetermined threshold value if the quality parameter is one of the following: FER, BER, or BLER.

6. A converter according to claim 1 wherein the converter is arranged so as to increase the number of basic packets in an RTP packet by one when the value of a quality parameter describing the quality of a connection exceeds a predetermined threshold value if the quality parameter is SIR.

7. A converter according to claim 1 wherein the converter is arranged so as to send to a backbone network RTP packets of a fixed length.

8. An application program in a functional element of a packet-switched telecommunication network operating on a real-time basis which application program comprises software means for implementing a real-time converter according to claims 1 to 7.

9. A computer program on a storage or transfer medium for loading an application according to claim 8 into the memory of a computer in order to realize a converter according to claims 1 to 7.

10. A packet-switched telecommunication network comprising a backbone network, fixed communications connections, operating nodes, base station subsystems and wireless terminals, which packet-switched telecommunication network further comprises both a converter connected to the backbone network and means in the terminals for determining the number of basic packets, which contain one or more data blocks, to be included in an RTP packet according to the IETF standard RFC 1889 on the basis of a measured quality parameter describing the quality of a communications connection.

11. A telecommunication network according to claim 10 wherein the quality parameter describing the quality of a communications connection is one of the following: frame error rate FER, block error ratio BLER, bit error rate BER, signal-to-interference ratio SIR.

12. A terminal of a telecommunication network operating on a packet-switched basis and comprising means for receiving and transmitting RTP packets, which further comprises means for determining the number of basic packets, which contain one or more data blocks, to be included in RTP packets on the basis of a quality parameter describing the quality of a communications connection.

13. A terminal according to claim 12 wherein the quality parameter describing the quality of a communications connection is one of the following: frame error rate FER, block error ratio BLER, bit error rate BER, signal-to-interference ratio SIR.

14. A telecommunication network terminal according to claim 11 which network further comprises means for changing the number of basic packets to be included in RTP packets on the basis of the quality parameter of the last received RTP packet.

15. A method for utilizing a real-time packet-switched connection between a terminal of a telecommunication network and a base station subsystem of a telecommunication network, in which method RTP packets are communicated from the base station subsystem towards a backbone network in fixed-length RTP packets according to the IETF standard RFC 1889 and where the number of basic packets, which contain one or more data blocks, to be included in RTP packets in the communication between the base station subsystem and terminal is determined on the basis of a quality parameter describing the quality of a communications connection.

16. A method according to claim 15 wherein a converter is used in the backbone network to determine the RTP packet length.

17. A method according to claim 16 wherein the quality parameter describing the quality of a communications connection is measured both at the converter and at the terminal, on the basis of which quality parameter the number of basic packets in RTP packets is determined.

18. A method according to claim 17 wherein the quality parameter is one of the following: frame error rate FER, block error ratio BLER, bit error rate BER, signal-to-interference ratio SIR.

19. A method according to claim 17 wherein the number of basic packets in an RTP packet is reduced by one when the value of the quality parameter exceeds a predetermined threshold value if the quality parameter is one of the following: FER, BER, or BLER.

20. A method according to claim 17 wherein the number of basic packets in an RTP packet is reduced by one when the value of the quality parameter drops below a predetermined threshold value if the quality parameter is SIR.

21. A method according to claim 17 wherein the number of basic packets in an RTP packet is increased by one when the value of said quality parameter drops below a predetermined threshold value if the quality parameter is one of the following: FER, BER, or BLER.

22. A method according to claim 17 wherein the number of basic packets in an RTP packet is increased by one when the value of said quality parameter exceeds a predetermined threshold value if the quality parameter is SIR.

23. A method according to claim 17 wherein the number of basic packets in an RTP packet is not changed if the value of the quality parameter lies between two predetermined threshold values.

24. A method according to claim 17 wherein a threshold value of the quality parameter is changed according to a message obtained from the receiving end.

25. A method according to claim 24 wherein the threshold of the quality parameter is transferred to the other end by using RTCP protocol.

26. A method according to claim 15 which further comprises a step where the receiver calculates the number of the basic blocks included in one RTP packet from information included in a payload header of the received RTP packet according to IETF standard RFC 3267.
